(19) United States
(12) Patent Application Publication
(10) Pub. No.: US 2014/0333744 A1
(43) Pub. Date: Nov. 13, 2014

(54) System and Method for Monitoring Potential Spread of an Infectious Agent in an Environment

(71) Applicant: Elwha LLC, (US)

(72) Inventors: Michael H. Baym, Cambridge, MA (US); Roderick A. Hyde, Redmond, WA (US); Muriel Y. Ishikawa, Livermore, CA (US); Clarence T. Tegreene, Mercer Island, WA (US); Lowell L. Wood, JR., Bellevue, WA (US)

(73) Assignee: Elwha LLC, Bellevue, WA (US)

(21) Appl. No.: 13/890,549

(22) Filed: May 9, 2013

(51) Int. Cl. G01P 13/00

(52) U.S. Cl. CPC G01P 13/00
USPC 348/77

(57) ABSTRACT

A system and a method are disclosed herein for monitoring potential spread of an infectious agent in an environment. A method is disclosed that includes providing a detectable marker/tracer for emplacement on one or more body regions of a subject at a time when the subject is entering the environment; identifying a unique tag/identifier associating the detectable marker/tracer with the subject; observing with a camera the marker/tracer in the environment; and detecting a transfer of the marker/tracer from the one or more body regions of the subject to one or more surfaces of the environment.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority application(s)). In addition, the present application is related to the “Related applications,” if any, listed below.

### PRIORITY APPLICATIONS

None.

### RELATED APPLICATIONS

None.

If the listings of applications provided above are inconsistent with the listings provided via an ADS, it is the intent of the Applicant to claim priority to each application that appears in the Priority applications section of the ADS and to each application that appears in the Priority applications section of this application.

All subject matter of the Priority applications and the Related applications and of any and all parent, grandparent, great-grandparent, etc. applications of the Priority applications and the Related applications, including any priority claims, is incorporated herein by reference to the extent such subject matter is not inconsistent herewith.

### SUMMARY

A system and a method are disclosed herein for monitoring potential spread of an infectious agent in an environment. The spread of the infectious agent may occur from an individual entering the environment and spreading the infectious agent throughout the immediate environment or into areas outside the immediate environment. A method for monitoring potential spread of an infectious agent in an environment is disclosed that includes providing a detectable marker/tracer for emplacement on one or more body regions of a subject at a time when the subject is entering the environment; identifying a unique tag/identifier associating the detectable marker/tracer with the subject; observing with a camera the marker/tracer in the environment; and detecting a transfer of the marker/tracer from the one or more body regions of the subject to one or more surfaces of the environment. In some embodiments the environment may include a hospital environment or a hospital MOM.

A method for monitoring potential spread of an infectious agent in an environment is disclosed that includes providing a detectable marker/tracer for emplacement on one or more body regions of a subject at a time when the subject is entering the environment; identifying a unique tag/identifier associating the detectable marker/tracer with the subject; observing with a camera the marker/tracer in the environment; and detecting a transfer of the marker/tracer from the one or more body regions of the subject to one or more surfaces of the environment.

The method may comprise observing the unique tag/identifier with the camera. In some aspects, the unique tag/identifier is identified by a spectral signature. The unique tag/identifier is identified by a fluorescence signature. The unique tag/identifier is identified by a fluorescence time signature. The method may include providing the subject with a different unique tag/identifier than one currently detected in the environment by the camera. The one or more body regions include one or more of hands, arms, legs, feet, head, or torso of the subject. The method may comprise detecting a degree of removal of the marker/tracer from the one or more body regions of the subject.

The method may comprise detecting a change in distribution of the marker/tracer on the one or more body regions of the subject. The method may further include detecting a time of the change in the distribution of the marker/tracer. The method may comprise detecting a change in distribution of the marker/tracer on the one or more surfaces of the environment. The method may further include detecting a time of the change in the distribution of the marker/tracer. The method may further include associating the change with an interaction event by the subject. The method may comprise detecting a change in distribution of the unique tag/identifier on the one or more surfaces of the environment. The method may comprise detecting the time of the change.

The method may comprise tracking a position of the one or more body regions of the subject in the environment. The method may comprise identifying a unique tag/identifier with a location in the environment. The marker/tracer is detectable may be one or more of infrared light, visible light, or ultraviolet light. The unique tag/identifier is configured within the detectable marker/tracer. The unique tag/identifier may be detectable in one or more of infrared light, visible light, or ultraviolet light.

The method may comprise alerting a third party of the detected transfer of the marker/tracer to the one or more surfaces of the environment. The third party includes one or more of a computing system, supervisory personnel, or one or more subjects in the environment. The method may comprise coordinating a history of the detected transfer of the marker/tracer with a contamination status of the surface of the environment or with an infective status of the subject. In the method, coordinating the history may be based on a previous infective status of the individual.

The method may comprise observing with the camera the marker/tracer on the one or more body regions of the subject; and alerting the subject to a status of the marker/tracer on the one or more body regions. In the method, detecting the transfer of the marker/tracer from the one or more body regions of the subject to one or more surfaces of the hospital environment comprises: detecting a transfer of the marker/tracer from the one or more body regions of the subject to one or more second subjects in the hospital environment. The method may further include comprising changing an infection status of the second subject. The method may comprise detecting a transfer of the marker/tracer from a surface of the environment to the second subject. The method may further include changing an infection status of the second subject. The method may comprise detecting removal of the marker/tracer from the hands or arms of the subject via a washing activity. The method may further include changing an infection status of the subject.

A method for monitoring potential spread of an infectious agent in a hospital environment is disclosed that includes providing a detectable marker/tracer for emplacement on one or more body regions of a subject at a time when the subject is in the hospital environment; identifying a unique tag/identifier associating the detectable marker/tracer with the subject; observing with a camera the marker/tracer in the hospital environment; and detecting a transfer of the marker/tracer from the one or more body regions of the subject to one or more surfaces of the hospital environment.

A system is disclosed that includes one or more recognition devices configured to identify a subject in an environment; one or more dispensers configured to dispense a detectable marker/tracer compound to one or more body regions of the subject, wherein the detectable marker/tracer compound is unique to the subject; one or more cameras configured to detect the marker/tracer in the environment; and a computing system configured to record and to correlate the location of the marker/tracer in the environment and the unique tag/identifier associated with the subject. The computing system is configured to identify a change in distribution of the marker/tracer on a surface of the environment with an emplacement event of the detectable marker/tracer on the subject. The computing system utilizing data from the one or more cameras is configured to detect a change in distribution of the marker/tracer on one or more body regions of the subject. The computing system utilizing data from the one or more cameras is configured to detect a change in distribution of the marker/tracer on the one or more surfaces of the environment. The data from the one or more cameras are configured to identify a change in distribution of the marker/tracer on a surface of the environment with an emplacement event of the detectable marker/tracer on the subject. The marker/tracer is detectable in one or more of infrared light, visible light, or ultraviolet light. The computing system utilizing data from the one or more cameras is configured to detect the marker/tracer on the one or more hands of the subject, and configured to alert the subject to a status of the marker/tracer on the one or more hands. The computing system utilizing data from the one or more cameras is configured to alert a third party of a detected transfer of the marker/tracer to the one or more surfaces of the environment. The one or more recognition devices include one or more RFID readers. The one or more recognition devices include a facial recognition system. The environment includes a hospital environment. The computing system is configured to coordinate a history of a detected transfer of the marker/tracer to the one or more surfaces of the environment or to the subject with a contamination status of the surface of the environment or with an infective status of the subject. The one or more cameras are configured to detect a transfer of the marker/tracer from the one or more body regions of the subject to one or more second subjects in the hospital environment. The computing system is configured to record a change in an infection status of the second subject.

A device is disclosed that includes a system including a signal-bearing medium and including one or more instructions for monitoring potential spread of an infectious agent in an environment including receiving data from one or more recognition devices configured to identify a subject in an environment; one or more instructions for receiving data from one or more dispensers configured to dispense a marker/tracer compound to one or more body regions of the subject, wherein the detectable marker/tracer compound is unique to the subject; one or more instructions for receiving data from one or more cameras configured to detect the marker/tracer in the environment; and one or more instructions for receiving data from and sending data to a computing system configured to record and to correlate the location of the marker/tracer in the environment and the unique tag/identifier associated with the subject.

A system is disclosed that includes at least one computer program included on a computer-readable medium for use with at least one computer system wherein the computer program includes a plurality of instructions and including one or more instructions for monitoring potential spread of an infectious agent in an environment including receiving data from one or more recognition devices configured to identify a subject in an environment one or more instructions for receiving data from one or more dispensers configured to dispense a marker/tracer compound to one or more body regions of the subject, wherein the detectable marker/tracer compound is unique to the subject; one or more instructions for receiving data from one or more cameras configured to detect the marker/tracer in the environment; and one or more instructions for receiving data from and sending data to a computing system configured to record and to correlate the location of the marker/tracer in the environment and the unique tag/identifier associated with the subject.

A system is disclosed that includes at least one computer program included on a computer-readable medium for use with at least one computer system wherein the at least one computer system includes a plurality of circuitry including, circuitry for one or more recognition devices configured to identify a subject in an environment; circuitry for one or more dispensers configured to dispense a marker/tracer compound to one or more body regions of the subject, wherein the detectable marker/tracer compound is unique to the subject; circuitry for one or more cameras configured to detect the marker/tracer in the environment; and circuitry for a computing system configured to record and to correlate the location of the marker/tracer in the environment and the unique tag/identifier associated with the subject.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a schematic of a diagrammatic view of a system for use in monitoring potential spread of an infectious agent in an environment.

FIG. 2 is a schematic of a diagrammatic view of a system for use in monitoring potential spread of an infectious agent in an environment.

FIG. 3 is a schematic of a diagrammatic view of a system for use in monitoring potential spread of an infectious agent in an environment.

FIG. 4 is a schematic of a diagrammatic view of a system for use in monitoring potential spread of an infectious agent in an environment.

FIG. 5 is a schematic of a diagrammatic view of a method for monitoring potential spread of an infectious agent in an environment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

A system and a method are disclosed herein for monitoring potential spread of an infectious agent in an environment. The spread of the infectious agent may occur from an individual entering the environment and spreading the infectious agent throughout the immediate environment or into areas outside the immediate environment. A method for monitoring potential spread of an infectious agent in an environment is disclosed that includes providing a detectable marker/tracer for emplacement on one or more body regions of a subject at a time when the subject is entering the environment; identifying a unique tag/identifier associating the detectable marker/tracer with the subject; observing with a camera the marker/tracer in the environment; and detecting a transfer of the marker/tracer from the one or more body regions of the subject to one or more surfaces of the environment. In some embodiments the environment may include a hospital environment or a hospital MOM.

A system is disclosed that includes one or more recognition devices configured to identify a subject in an environment; one or more dispensers configured to dispense a detectable marker/tracer compound to one or more body regions of the subject, wherein the detectable marker/tracer compound is unique to the subject; one or more cameras configured to detect the marker/tracer in the environment; and a computing system configured to record and to correlate the location of the marker/tracer in the environment and the unique tag/identifier associated with the subject. In some embodiments, the subject may be a medical professional.

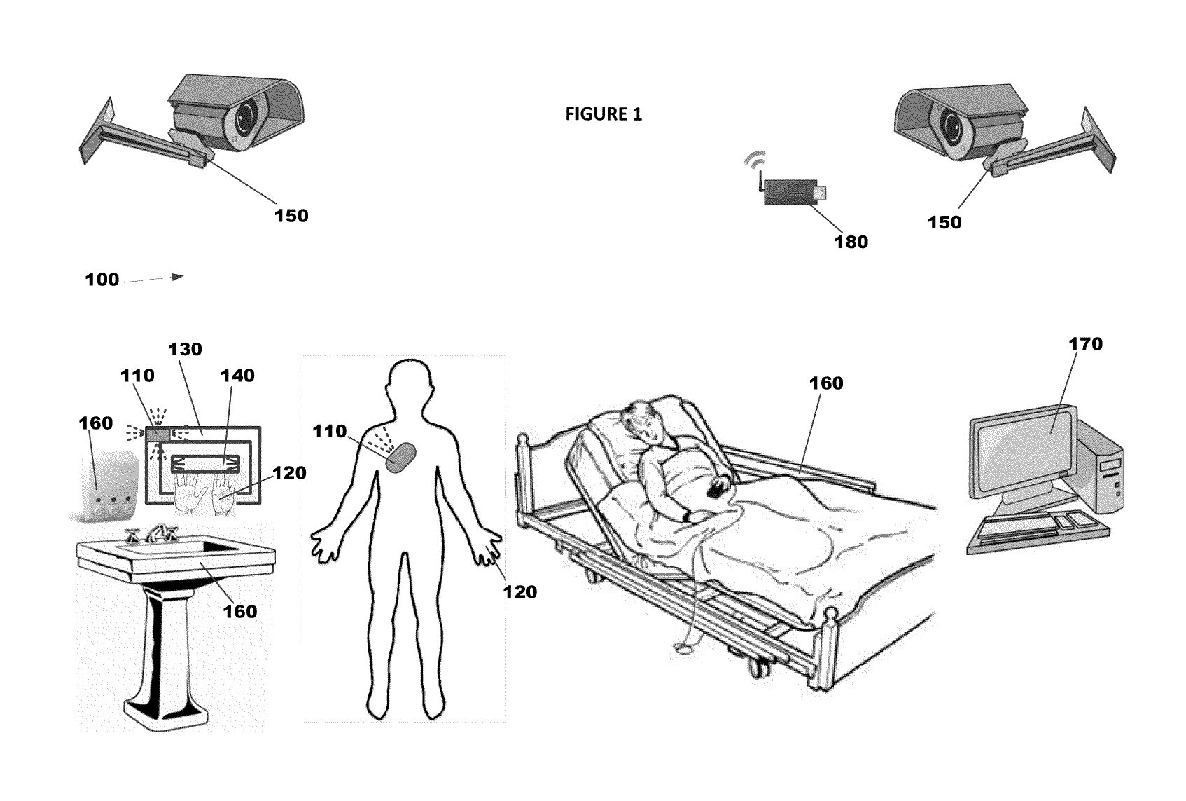

FIG. 1 is a schematic of a diagrammatic view of a system for use in monitoring potential spread of an infectious agent in an environment, such as a hospital environment. A system 100 is disclosed that includes one or more recognition devices 110 configured to identify a subject 120; one or more dispensers 130 configured to dispense a tracer tag/identifier 140 unique to the subject 120; one or more cameras 150 configured to detect the unique tag/identifier 140 in a hospital environment 160; and a computing device 170 in communication with a wireless communication device 180, wherein the computing device 170 is configured to record and to correlate the location of the unique tracer tag/identifier 140 in the hospital environment 160 and the unique tracer tag/identifier 140 associated with the subject 120. In some embodiments, the camera system may be mounted in the hospital environment, for example, on one or more walls of the hospital room. In some embodiments, the subject 120 may be a medical professional. The medical professional 120 may enter the patient's room and wash her hands. The medical professional 120 would then place her hands in the dispenser 130 to be positively identified by the recognition device and to mark her hands with the unique tracer tag/identifier 140.

A surveillance system 100 may observe and record activities of the healthcare worker 120 and the presence of potential infectious agents on the healthcare worker when the healthcare worker prepares to leave the patient's room 160. Before leaving the patient's room the healthcare worker removes his/her gloves and gown and washes their hands as recommended for “Contact Precautions” by the Centers for Disease Control and Prevention, Atlanta, Ga. Also the healthcare worker may apply a hand sanitizer before leaving the patient's room. The one or more recognition devices 110, e.g., a CCD camera, over the wash basin will image the healthcare workers gloves and hands before and after washing, and also record images of the worker's hair, the doorknob, the door and his/her exit from the room 160. Similar CCD cameras 110 in hallways or other rooms 160 can detect the presence of tracer tag/identifier 140 particles applied to a healthcare worker 120 in a first room and not removed by washing upon exiting the room 160. The images recorded by the monitoring system 150, e.g., the one or more cameras, will include the date, time, location and identity of the healthcare worker 120 and his/her associated tracer tag/identifier 140 particles. The images are sent to a computer system 170 for storage of the data. The images may be retrieved and analyzed at a later time in the event MRSA infections spread in the hospital environment 160. The potential transfer of MRSA by healthcare workers 120 may be indicated by images of fluorescent tracer particles 140 on the healthcare workers or hospital room surfaces 160 prior to or concurrent with the spread of MRSA.

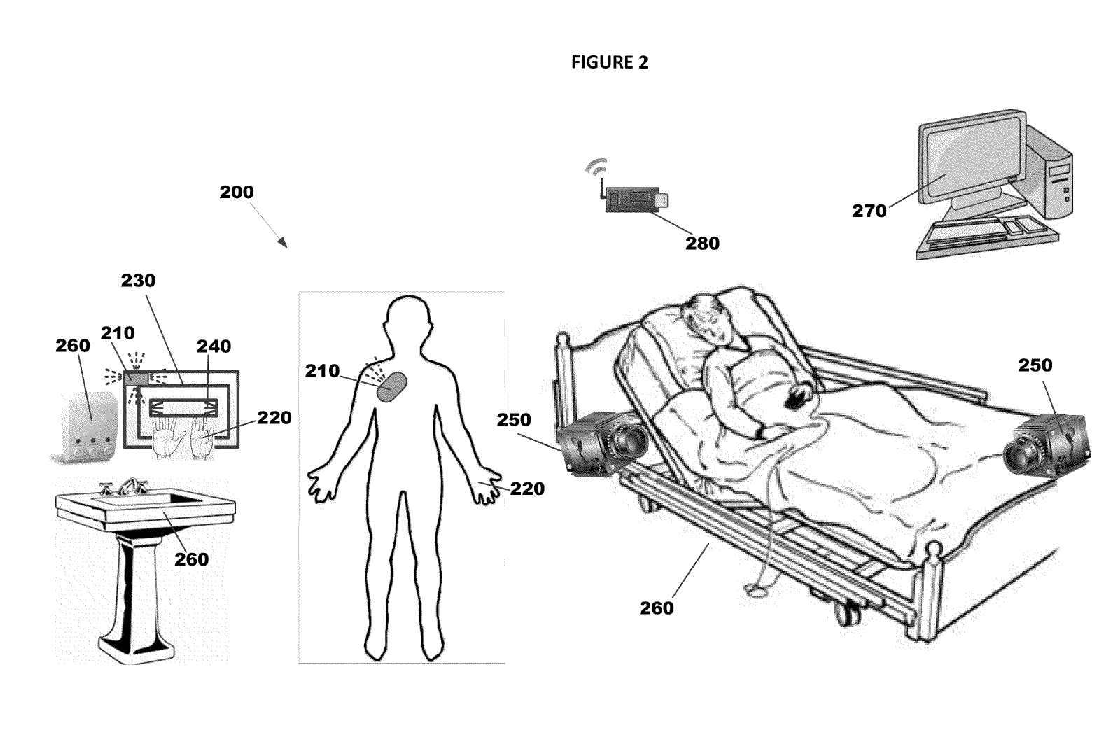

FIG. 2 is a schematic of a diagrammatic view of a system for use in monitoring potential spread of an infectious agent in an environment, such as a bedroom of an infected patient. A system 200 is disclosed that includes one or more recognition devices 210 configured to identify a subject 220; one or more dispensers 230 configured to dispense a tracer tag/identifier 240 unique to the subject 220; one or more cameras 250 configured to detect the unique tag/identifier 240 in an environment 260; and a computing device 270 in communication with a wireless communication device 280, wherein the computing device 270 is configured to record and to correlate the location of the unique tracer tag/identifier 240 in the environment 260 and the unique tracer tag/identifier 240 associated with the subject 220. In some embodiments, the camera system may be mounted in the environment, for example, at one or more locations on the bed in the patient's room. In some embodiments, the subject 220 may be a medical professional. The medical professional 220 may enter the patient's room and wash her hands. The medical professional 220 would then place her hands in the dispenser 230 to be positively identified by the recognition device and to mark her hands with the unique tracer tag/identifier 240.

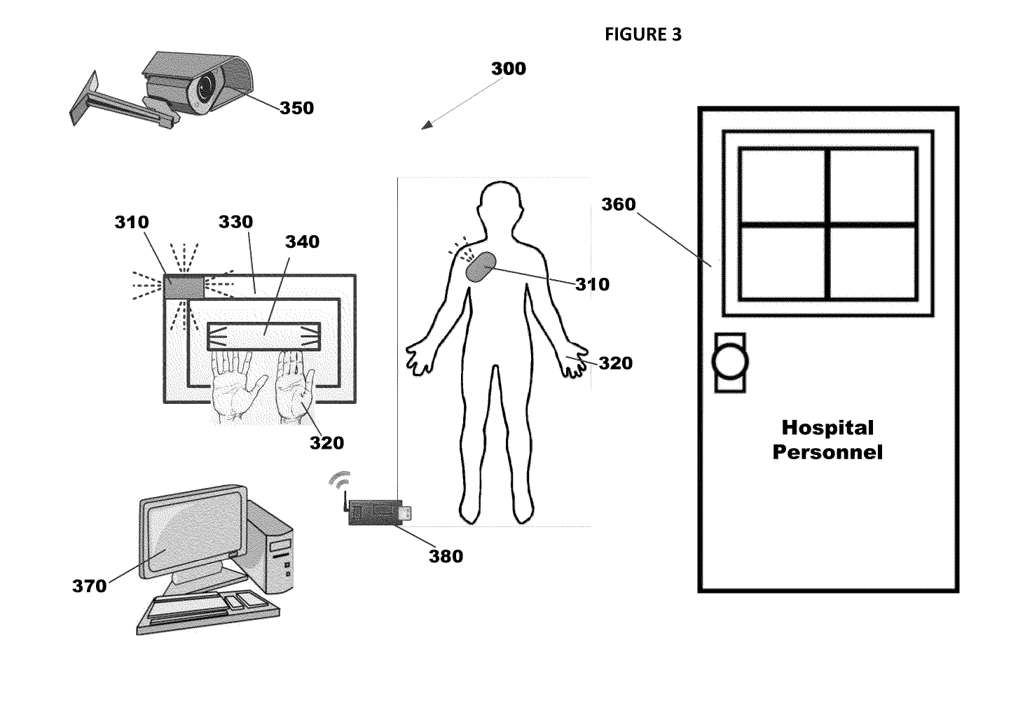

FIG. 3 is a schematic of a diagrammatic view of a system for use in monitoring potential spread of an infectious agent in an environment, such as a hospital environment. A system 300 is disclosed that includes one or more recognition devices 310 configured to identify a subject 320; one or more dispensers 330 configured to dispense a tracer tag/identifier 340 unique to the subject 320. In some embodiments, the subject 320 may be a medical professional. The medical professional 320 may enter a medical environment 360, e.g., a hospital or a section of the hospital, where she may then place her hands in the dispenser 330 to be positively identified by the recognition device 310 and to mark her hands with the unique tracer tag/identifier 340.

The system 300 may include one or more cameras 350 situated in various locations throughout the medical environment 360, for example, in a patient's room or in corridors leading to patients' room in a hospital. The one or more cameras 350 may be configured to detect the unique tag/identifier 340 in the medical environment 360. The system may include a computing device 370 in communication with a wireless communication device 380, wherein the computing device 370 is configured to record and to correlate the location of the unique tracer tag/identifier 340 in the medical environment 360 and the unique tracer tag/identifier 340 associated with the medical professional 320. In some embodiments, the one or more cameras 350 may be mounted in the medical environment 360, for example, at one or more locations on the hospital bed or on one or more walls of the hospital room or hospital corridors.

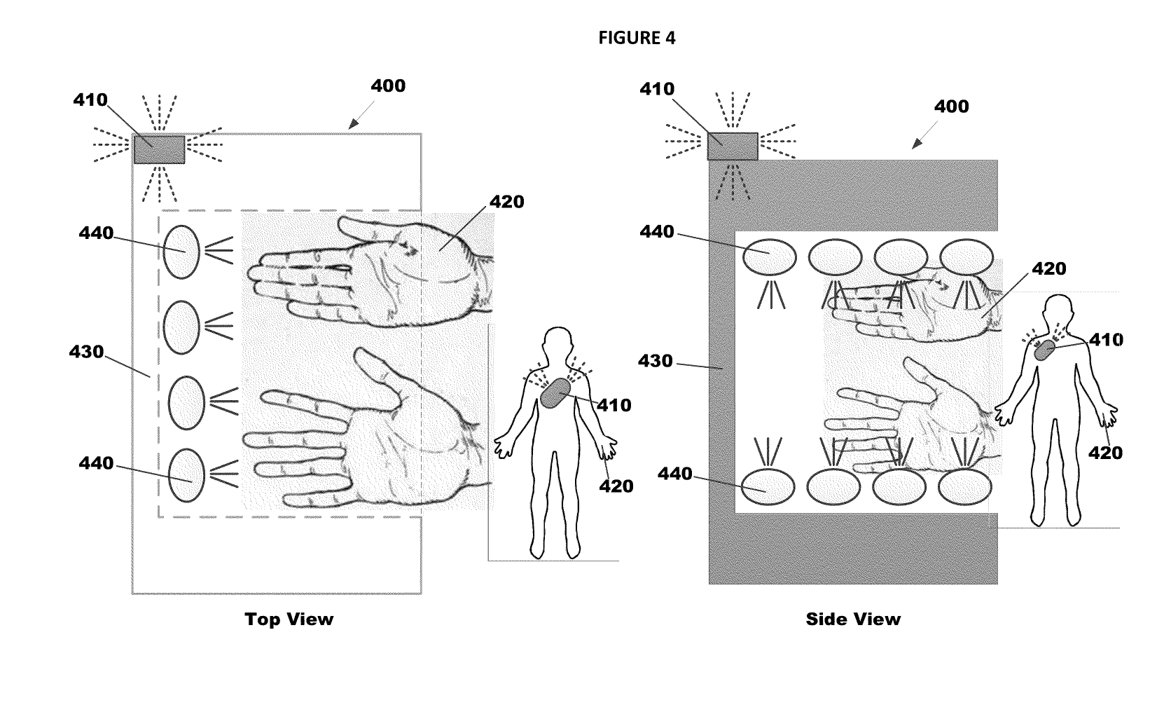

FIG. 4 is a schematic of a diagrammatic view of a system for use in monitoring potential spread of an infectious agent in an environment, such as a hospital environment. A system 400 is disclosed that includes one or more recognition devices 410 configured to identify a subject 420; one or more dispensers 430 configured to dispense a tracer tag/identifier 440 unique to the subject 420. In some embodiments, the subject 420 may be a medical professional. The medical professional 420 may enter a medical environment 460, e.g., a hospital building, a section of the hospital, or a patient's room. Upon entry, she may place her hands in the dispenser 430 to be positively identified by the recognition device 410 and to subsequently mark her hands with the unique tracer tag/identifier 440.

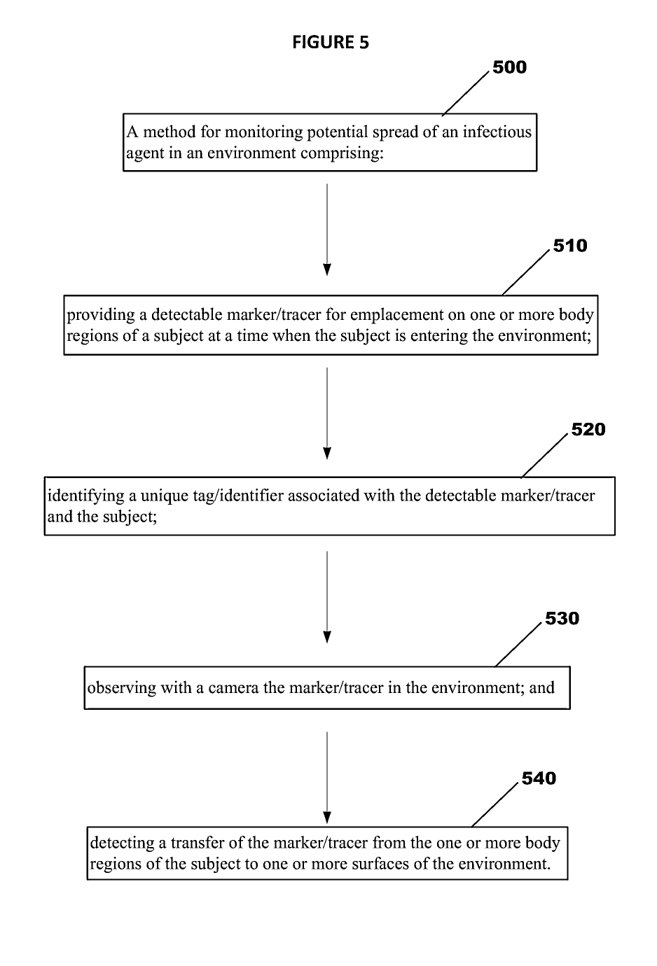

FIG. 5 is a schematic of a diagrammatic view of a method 500 for monitoring potential spread of an infectious agent in an environment that includes providing 510 a detectable marker/tracer for emplacement on one or more body regions of a subject at a time when the subject is entering the environment; identifying 520 a unique tag/identifier associated with the detectable marker/tracer and the subject; observing 530 with a camera the marker/tracer in the environment; and detecting 540 a transfer of the marker/tracer from the one or more body regions of the subject to one or more surfaces of the environment.

### Dispensers Configured to Dispense a Marker/Tracer Compound as Fluorescent Tracer Particles

The system may include one or more dispensers configured to dispense a marker/tracer compound unique to a subject in an environment. The marker/tracer compound may include one or more tracer particles including fluorescent tracer particles. Fluorescent tracer particles may contain fluorescent compounds that emit visible (VIS) light (wavelengths approximately 380 nm-750 nm) or near infrared (NIR) light (wavelengths approximately 750 nm-1100 nm) when irradiated with a light source. For example, fluorescent compounds are available with different emission maxima ranging between 432 nm and 794 nm. See e.g., “DyLight Fluor Absorption and Emission Spectra” available from Thermo Fisher Scientific Inc., Rockford, Ill. which is incorporated herein by reference. The fluorescent tracer particles may also contain phosphorescent compounds containing rare earth metals. For example, phosphorescent particles are excited by infrared wavelengths, e.g., 800-1400 nm or 700-1500 nm, and emit at visible wavelengths, e.g., 490-650 nm. See e.g., “Phosphor Technology Product List” available from Phosphor Technology Ltd., Stevenage, Herts, UK, which is incorporated herein by reference.

Unique tracer particles may be developed using combinations of fluorescent and phosphorescent compounds. It is possible to create multiple different tracer particles with unique optical signatures by combining different phosphors and fluors, e.g., 24-36 unique optical signatures may be created by combining two different NIR fluors and phosphors; more can be created by combining three or four different phosphors and fluors. See e.g., U.S. Patent Application No. 2011/0258924 by Van Asbrouck et al. published on Oct. 27, 2011 which is incorporated herein by reference. The unique tracer particles may include one or more of near infrared (NIR) markers, ultraviolet (UV) markers, and visible (VIS) markers.

The tracer particles including combinations of fluorescent and phosphorescent compounds may be used in an upconversion process which refers to a process where light can be emitted with photon energies higher than those of the light generating the excitation. Photoexcitation at a certain wavelength in the near infrared (NIR) followed by luminescence at a shorter wavelength in the VIS is called NIR to VIS photon upconversion. An upconversion marker is selected from the group consisting of the markers 50020, F0027, Y0037, A0007, Z0011, and K0080 available from BrandWatch™ Global Technologies, Seattle, Wash., USA, and the markers PTIR475, PTIR545, PTIR550, and PTIR660, available from Phosphor Technology Ltd, Stevenage, Herts, UK.

In the upconversion process of the tracer particles, low energy photons are “converted” to higher energy photons. At least two NIR photons are required to generate one VIS photon. When a medium, e.g., a laser gain medium, emits fluorescence as a consequence of being excited with incident light, the wavelength of the fluorescence is usually longer than that of the exciting light. This means that the photon energy is reduced. However, under some circumstances upconversion fluorescence can occur, where the wavelength of the emitted light is shorter. This is possible via excitation mechanisms which involve more than one absorbed photon per emitted photon. One kind of mechanism is sequential absorption of pump photons by excited state absorption. A first absorption process leads to some metastable excited level, from where further absorption can take the ion to even higher levels. Such processes require high pump intensities, but not necessarily high doping concentrations. One energy efficient method for generating such high pump intensities is to use short pulse irradiation, such as nanoseconds or less. With suitable level configurations, e.g., as in thulium (Tm³⁺) ions, a single pump laser can be used for all excitation steps, but there are cases where multiple pump wavelengths are required. Another type of mechanism involves energy transfer processes between different laser ions. In some embodiments, two laser ions in a metastable intermediate level interact to generate one ion in a higher lying state while the other one becomes deexcited, e.g., cooperative upconversion. High doping densities are usually required in order to enable such energy transfers. Even at lower doping densities, some host media have a tendency for clustering of the dopants, facilitating energy transfers.

The near infrared (NIR) marker may include, but is not limited to, FHI 8162, FHI 7782, FHI 8082, FHI 8022, and FHI 7832, available from Fabricolor Holding Inc., Paterson, N.J., and the invisible inks marketed under the name ClirCode available from Eastman Chemical Company, Kingsport, Tenn., and the IR dye 700 and 800 labels available from LI-COR Biosciences, Lincoln, Nebr.

The ultraviolet (UV) marker may include, but is not limited to, fluoresceins, rhodamines (FAM, R6G, TAMRA, and ROX), Texas red, BODIPY, coumarins, cyanine dyes (thiazole orange [TO], oxazole yellow [YO], TOTO, YOYO; Cy3, Cy5), and Alexa dyes.

The visible (VIS) marker may include regular visible dyes. Examples of visible dyes include, but are not limited to, fluorescein derivatives, rhodamine derivatives, coumarins, azo dyes, metalizable dyes, anthraquinone dyes, benzodifuranone dyes, polycyclic aromatic carbonyl dyes, indigoid dyes, polymethine dyes, azacarbocyanine dyes, hemicyanine dyes, barbituates, diazahemicyanine dyes, stryrl dyes, diaryl carbonium dyes, triaryl carbonium dyes, phthalocyanine dyes, quinophthalone dyes, triphenodioxazine dyes, formazan dyes, phenothiazine dyes, such as methylene blue, azure A, azure B, and azure C, oxazine dyes, thiazine dyes, naphtholactam dyes, diazahemicyanine dyes, azopyridone dyes, azobenzene dyes, mordant dyes, acid dyes, basic dyes, metallized and premetallized dyes, xanthene dyes, direct dyes, Ieuco dyes which can be oxidized to produce dyes with hues bathochromically shifted from those of the precursor Ieuco dyes, and any other visible dyes known in the art.

The phosphorescent (Phos) marker (also commonly referred to as “glow-in-the dark” marker) is selected from the group consisting of europium-, dysprosium-, and/or terbium-doped lutetium orthophosphate (LuPO.sub.4:Eu/Dy/Tb); europium-, dysprosium-, and/or terbium-doped strontium aluminate (SrAl₂O₄: Eu/Dy/Tb); europium-, dysprosium-, and/or terbium-doped strontium magnesium silicate (Sr₂MgSi₂O₇:Eu/Dy/Tb), copper-activated zinc sulphide (ZnS:Cu); silver-activated zinc sulfide (ZnS:Ag); copper-activated zinc-cadmium sulphide ((Zn,Cd)S:Cu) and bismuth-activated calcium-strontium sulfide ((Ca,Sr)S:Bi). See e.g., U.S. Patent Application No. 2011/0258924, which is incorporated herein by reference.

A system and method for monitoring potential spread of an infectious agent in an environment may include one or more recognition devices configured to identify a subject in the environment. The recognition device for video capture of an object may include a strobed illumination system synchronized to a video capture system. The method and system may be used to control illumination of any object that is susceptible to damage from excessive illumination. Cameras and illumination sources are placed in the hospital room to capture the healthcare worker's hands, frequently contacted surfaces and the patient. For example, cameras may be placed overhead on the ceiling and on the bedside to capture images of the health care worker's hands, bed rails, bed table, door knobs, doors, call button, and sink area which are frequently contaminated by healthcare associated pathogens. See, e.g., FIGS. 1 and 2. The cameras and illumination sources of the monitor system may use pulsed lighting and synchronized frame acquisition to maximize detection of fluorescent tracer particles and increase the signal to noise ratio. Pulsed lighting systems may include an illuminator, a lighting controller, camera controller and a camera. In some embodiments, an illumination controller for light-emitting diode (LED)/laser diode arrays can generate strobed illumination that is synchronized with a camera. The duration, intensity and position of the illumination sources (strobes) with respect to the start and duration of image capture frames are adjustable to optimize performance for specific applications; this timing can be matched to the fluorescence decay rate of a given marker in order to distinguish from ambient illumination or from other spectrally similar markers. The light intensity is increased during the strobe period so that adequate signal to noise may be maintained, while the average irradiance remains below threshold limit values for safe exposure of the subject or the object to be illuminated. See, e.g., U.S. Pat. No. 7,542,628, which is incorporated herein by reference.

The recognition device for video capture of an object may include an illumination system synchronized to a video capture system. The illumination system may advantage of the temporal persistence of the human visual system, such that individual electromagnetic energy pulses at higher frequencies are less discernible than individual electromagnetic energy pulses at lower frequencies. An illuminator may be controlled by a lighting controller, which is synchronized by a camera controller to a camera that acquires frames. An optional photodiode can also be connected to the lighting controller. The illuminator projects light onto the optional photodiode as well as on the subject. The illumination is reflected off the subject, and an image of the subject is captured using the camera. See, e.g., U.S. 2012/0187838, which is incorporated herein by reference.

In some embodiments, the method includes the steps of sensing the actual output of at least one of the first and second illumination modalities, and adjusting the output of at least one of the first and second illumination modalities in response to the output sensed in the sensing step. One example is to provide at least one photodiode for detecting the output of one or more modalities and to connect the photodiode to the controller(s) of the one or more illumination sources to provide feedback to the controller(s).

If the acquired frame rate and illumination pulse rate is set too low, then the performance of the recognition device can be impacted since not enough frames are being acquired in a sufficient time period for reliable acquisition of imagery of the subject. On the other hand, if the acquired frame rate and illumination pulse rate is set at the highest possible rate for the sensor, which may be close to 15 frames and illumination pulses per second, then the illumination pulse rate is close to the peak response for photosensitive epilepsy.

To overcome a problem of an epileptic response in the subject induced by light impulses, the camera system and recognition device uses a different pulse rate for the illumination compared to the frame acquisition rate of the sensor, such that a portion of the illumination pulses are still synchronized with frame acquisition but where the remaining portion of illumination pulses is not. The camera system provides a first set of pulses that coincide with frame/image capture (the synchronized pulses), while a second set of pulses are triggered at other times (the asynchronous pulses). The pulse rate of the illumination is set sufficiently high in order to take advantage of the persistence of the human visual system so that the illumination pulses appear almost unnoticed to the subject, but a subset of the pulses are still synchronized to the lower frame acquisition rate so that illumination is provided at the lower frequency in order to provide high-quality, well-illuminated imagery. In this way, photosensitive epilepsy or discomfort to the user is not a concern, even though images are being illuminated and acquired at a rate to which the human eye is much more sensitive. See, e.g., U.S. 2012/0187838, which is incorporated herein by reference.

A method for monitoring potential spread of an infectious agent in a hospital environment may include placing a detectable marker/tracer on one or more hands of a subject at a time when the subject is in the hospital environment. Precautions to prevent spread of highly infectious disease are taken as a standard operating procedure according to guidelines of the Centers for Disease Control. “Contact precautions” are outlined as a standard operating procedure for highly infectious hospital patients that may be utilized in combination with fluorescent tracers and a contact monitoring system. For example, a patient infected with and infectious microorganism, e.g., methicillin resistant Staphylococcus aureus (MRSA) is placed in a private room in a hospital and “contact precautions” are observed. See e.g., “Precautions to Prevent the Spread of MRSA in Healthcare Settings” August 2010 available from Centers for Disease Control and Prevention, Atlanta, Ga. or online at: http://www.cdc.gov/mrsa/prevent/healthcare/precautions.html, which is incorporated herein by reference. Contact precautions may be utilized in combination with fluorescent tracers and monitoring system that include one or more of the following procedures: Healthcare workers don gloves and gown upon entry into the patient's room and remove the gown and gloves before leaving the room. Hand hygiene is performed after removing the gloves but prior to leaving the room. A monitoring system with fluorescent tracer particles and cameras is employed to monitor the healthcare workers and the hospital room surfaces that the health care workers contact. The monitoring system may include detection of contact between the health care workers and the patient in the room or detection of contact by the patient to locations in the room.

“Standard Precautions” according to the CDC recommendations that should control the spread of infectious microorganisms such as MRSA in most instances include: 1) Hand Hygiene: Perform hand hygiene after touching blood, body fluids, secretions, excretions, and contaminated items, whether or not gloves are worn; 2) Gloving: Wear gloves (clean nonsterile gloves are adequate) when it can be reasonably anticipated that contact with blood or other potentially infectious materials, mucous membranes, nonintact skin, or potentially contaminated intact skin could occur; 3) Mouth, nose, eye protection: Use personal protective equipment to protect the mucous membranes of the eyes, nose and mouth during procedures and patient-care activities that are likely to generate splashes or sprays of blood, body fluids, secretions and excretions; 4) Gowning: Wear a gown, that is appropriate to the task, to protect skin and prevent soiling or contamination of clothing during procedures; 5) Appropriate device handling of patient care equipment and instruments/devices: Handle used patient-care equipment soiled with blood, body fluids, secretions, and excretions in a manner that prevents skin and mucous membrane exposures, contamination of clothing, and transfer of microorganisms to other patients and environments; 6) Appropriate handling of laundry: Handle, transport, and process used linen to avoid contamination of air, surfaces and persons.

“Contact Precautions” is a protocol recommended by the CDC when the facility (based on national or local regulations) deems a highly infectious organism, e.g., MRSA, to be of special clinical and epidemiologic significance. The components of contact precautions may be adapted for use in non-hospital healthcare facilities, especially if the patient has draining wounds or difficulty controlling body fluids. These contact precautions should be followed for some patients including: 1) Patient placement: In Patient placement in hospitals and long term care facilities, when single-patient rooms are available, assign priority for these rooms to patients with known or suspected MRSA colonization or infection; 2) Gloving: Wear gloves whenever touching the patient's intact skin or surfaces and articles in close proximity to the patient e.g., medical equipment, bed rails. Don gloves upon entry into the room or cubicle; 3) Gowning: Don gown upon entry into the room or cubicle. Remove gown and observe hand hygiene before leaving the patient-care environment; 4) Patient transport: In acute care hospitals and long-term care and other residential settings, limit transport and movement of patients outside of the room to medically-necessary purposes; 5) Patient-care equipment and instruments/devices: In acute care hospitals and long-term care and other residential settings, use disposable noncritical patient-care equipment (e.g., blood pressure cuffs) or implement patient-dedicated use of such equipment; 6) Environmental measures: Ensure that rooms of patients on Contact Precautions are prioritized for frequent cleaning and disinfection, e.g., at least daily, with a focus on frequently-touched surfaces, e.g., bed rails, overbed table, bedside commode, lavatory surfaces in patient bathrooms, doorknobs, and equipment in the immediate vicinity of the patient; 7) Discontinuation of Contact Precautions: No recommendation can be made regarding when to discontinue Contact Precautions. See, e.g., “Precautions to Prevent the Spread of MRSA in Healthcare Settings” August 2010 available from Centers for Disease Control and Prevention, Atlanta, Ga., which is incorporated herein by reference.

A method for monitoring potential spread of an infectious agent in a hospital environment may include placing a detectable marker/tracer on one or more hands of a subject at a time when the subject is in the hospital environment and identifying a unique tag/identifier with the subject. The method includes a procedure for a proactive hand hygiene monitoring system. As part of a standard operating procedure, a healthcare worker who attends to the patient dons gloves and a gown before entering the patient's room. Soap or disinfectant dispensers that include detectable tags may include RFID readers that respond to an individual's RFID badge. The healthcare worker also applies a hand sanitizer containing unique tracer compounds to their hands and gloves before entering the room. A proactive hand hygiene monitoring system utilizes: (1) An intelligent identification tag (can be in the form of a key badge, wrist band or a foot ankle band) assigned to each personnel to be monitored, which uses active RFID or a combination of passive and active RFID technology to interact with pre-programmed soap and/or rinse-free disinfectant dispensers as well as entry-exit sensors to record the time-date of each of this person's hand hygiene event and its thoroughness. Based on the RFID tag record and notification from an entry-exit sensor, it will also proactively prompt (by either vibration or low tone) the wearer to conduct hand cleaning prior to perform the next task, such as handling next patient or after handling raw meat. (2) Pre-programmed soap and rinse-free disinfectant dispensing (wall-mounted and/or counter top placed) units which will notify a user's ID tag via radio frequency of the dispensers' own unique identification codes after triggering by that user's ID tag. (3) Entry-exit sensors which will detect the entering into or exiting from a controlled access area of one or more persons and inform each person's ID tag via radio frequency to record the time-date of the unique identification codes of the sensor as well as prompting each ID tag to check the last time of hand hygiene event of the wearer to determine whether a prompt for hand cleaning is required. (4) Data transfer stations which will download the recorded data from every personnel ID tag placed on their slots. They will verify the data integrity and convert them into a proper format (such as TCP/IP for Ethernet) for transmission to the central data processor (computer). They will also charge the internal battery of an ID tag to maintain its functionalities. (5) A central computer (which can be a personal computer or a server) which will receive the collected data from all the data transfer stations and processing them into a daily and/or periodic hand hygiene compliance report. It will also query the maintenance conditions of each component of this system (such as soap and rinse-free disinfectant refills as well as battery power level) and perform diagnostic to detect any malfunctions. During the data collection process, it will synchronize its clock with all the ID tags to assure the entire system is in synchronization with respect to timing of all events. It will also archive all the collected data and information.

By using appropriate electronics and instruction sets, the hand hygiene monitoring system provides: (1) continuous monitoring, (2) timely unobtrusive reminder to the staff to wash or clean hands, (3) no disruption to the regular work flow or handwashing procedure, (4) absolute accuracy in identifying a person undergoing handwashing or cleaning. It is a system that can deliver the performances demanded by healthcare settings, to minimize cross infection by staff due to lack or improper hand hygiene. See, e.g., U.S. 2009/0195385, which is incorporated herein by reference.

While physical ID tags are one approach to providing personal identification of the subject, other approaches such as biometric ID methods may be employed. Such methods include fingerprints, retinal scans, or the like. In one such approach, biometric identification may be provided by camera-based facial recognition; either against a population-wide data set, or one limited to personnel having access to the environment.

The method includes one or more cameras for observing the detectable marker/tracer in the hospital environment. Multi-CCD cameras are capable of providing simultaneous images of different light spectrums through a single optical path. This multi-spectral technology can replace multiple inspection stations with a one-camera solution offering easier setup, greater accuracy, and lower equipment cost. For example, a 2-CCD Area Scan camera splits the incoming light into two separate channels—a visible color channel from 400-700 nm and a near-infrared (NIR) channel at 750-900 nm. This enables simultaneous inspection of surface colors or printing, as well as sub-surface defects or other information which can only be detected using NIR wavelengths. See e.g., “Camera Selection Guide” available from JAI Inc., San Jose, Calif. which is incorporated herein by reference.

A tri-linear camera may be utilized for imaging the detectable marker/tracer at an angle. When a tri-linear camera is positioned at an angle to the viewing surface, substantial compensation must be performed in the preprocessing circuit to account for issues caused by the spacing between the R, G, and B sensors. 3-CCD or 3-CMOS cameras do not require such compensation due to their single optical axis, so preprocessing power can be devoted to other tasks.

Cameras capable of developing three-dimensional images may be used. These can employ two or more cameras to provide stereoscopic images. The cameras can combine a conventional two-dimensional camera image with range information from a range sensor (e.g., lidar or radar). A camera can determine range information by comparing image sharpness to known focal depth characteristics of the camera. Use of three dimensional imagery can improve the system's capability to track motions of a subject's arms or hands, to determine potential interaction events (e.g., contacts) with surfaces or other subjects in the environment. Such potential interactions can be identified with a first (2-D or 3-D) camera system (e.g., one not capable of uniquely identifying markers or tracers) and then used to trigger detailed examination of the surface or subject's body part by a second camera system (e.g., one which is capable of uniquely identifying markers or tracers).

The camera may be utilized for inspection of objects in the environment with a wavy or undulating surface. Wavy or undulating materials can make it nearly impossible to calculate when each tri-linear sensor will be scanning the same line on a continuous web surface. 3-CCD and 3-CMOS cameras capture images via a single optical axis, eliminating parallax issues and enabling objects with wavy surfaces to be easily inspected. See e.g., “Camera Selection Guide” available from JAI Inc., San Jose, Calif. which is incorporated herein by reference.

### PROPHETIC EXEMPLARY EMBODIMENTS

### Example 1

### A Monitor System for a Hospital Room to Monitor Physical Contact of Healthcare Workers with a Patient and with Surfaces in the Patient's Room

The monitor system includes cameras and tracer compounds to monitor healthcare workers and surfaces in a hospital room for potential spread of infectious disease. Tracer compounds are applied to the healthcare workers' hands before entry into a patient's room. Inside the room, cameras are installed which include light sources to specifically illuminate the tracer compounds. The cameras collect images of the tracer compounds on the healthcare workers' hands and any tracers left on surfaces in the hospital room. The images are stored on a computer hard drive, and each image includes the camera location, e.g., room number, bedside, floor, overhead, and the identity of the healthcare worker associated with each tracer compound.

Fluorescent tracer compounds are applied to healthcare workers' hands to permit tracking of contacts made by the worker with hospital room surfaces and patients. For example a fluorescent tracer formulated as particles may be applied to the healthcare worker's hands as part of a hand sanitizer. Fluorescent tracer particles may contain fluorescent compounds that emit visible (VIS) light (wavelengths approximately 380 nm-750 nm) or near infrared (NIR) light (wavelengths approximately 750 nm-1100 nm) when irradiated with a light source. For example fluorescent compounds with different emission maxima ranging between 432 nm and 794 nm are available (see e.g., “DyLight Fluor Absorption and Emission Spectra” available from Thermo Fisher Scientific Inc., Rockford, Ill. which is incorporated herein by reference). The tracer particles may also contain phosphorescent compounds containing rare earth metals. For example phosphorescent particles which are excited by infrared wavelengths and emit at visible wavelengths are available (see e.g., “Phosphor Technology Product List” available from Phosphor Technology Ltd., Stevenage, Herts, UK which is incorporated herein by reference). Methods and materials to make unique tracer particles with combinations of fluorescent and phosphorescent compounds are described (see e.g., U.S. Patent Application No. 2011/0258924 by Van Asbrouck et al. published on Oct. 27, 2011 which is incorporated herein by reference). Combinations of different fluorescent and phosphorescent compounds with different absorption and emission spectra may be used to create personalized tracer particles with unique optical signatures which may be assigned to each healthcare worker. For example a unique fluorescent tracer particle may contain: 1) Dylight 800 NIR fluorescent dye with an excitation maximum at 777 nm and emission maximum at 794 nm, and 2) PTIR475/F phosphorescent particle with excitation maximum at 950 nm and emission maximum at 480 nm. See e.g., “DyLight Fluor Absorption and Emission Spectra” from Thermo Fisher Scientific Inc., Rockford, Ill. and Phosphor Technology Ltd., Stevenage, Herts, UK, which is incorporated herein by reference. Excitation of the tracer particle with NIR light will result in fluorescence at 794 nm and phosphorescence at 480 nm, a unique optical signature, which may be associated with a specific healthcare worker. It is possible to create multiple different tracer particles with unique optical signatures by combining different phosphors and fluors, e.g., 24-36 unique optical signatures may be created by combining NIR fluors and phosphors (see e.g., U.S. Patent Application No. 2011/0258924, Ibid.)

Tracer particles may be formulated in a hand sanitizer (e.g., Purell® hand sanitizer available from GoJo Industries, Inc., Akron, Ohio) and applied to the healthcare worker's hands, or to their gloved hands before entering and leaving a patient room. Tracer particles formulated as liquids, gels and powders which transfer from surfaces, and objects to the hands are available from Glo Germ Company, Moab, Utah, and camera systems to quantitate transfer of fluorescent compounds to and from the hands are described (see e.g., Hubal et al., J. Expo. Anal. Environ. Epidemiol. 15: 261-270, 2005 which is incorporated herein by reference). Personal containers of hand sanitizer containing a healthcare worker's unique tracer particle may be placed outside and inside hospital rooms which may be attended by the healthcare worker. The container has a RFID reader to identify the healthcare worker who is wearing a RFID badge and to restrict access to the hand sanitizer and personalized tracer particles.

The monitor system uses cameras and illumination sources to image fluorescent tracer particles and to create a continuous record of the surfaces contacted by a healthcare worker while in the patient's room. Fluorescent tracer particles may be deposited on hospital room surfaces, on patients and on the healthcare worker's clothes and body when contacted by the healthcare worker's hands or gloves. For example touching the patient's arm and installing an infusion line may lead to transfer of fluorescent tracer particles to the patient's arm and on to the line. Moreover the hands of the worker may show a depletion of fluorescent tracer particles at the sites of contact. Cameras and illumination sources are placed in the hospital room to capture the healthcare worker's hands, frequently contacted surfaces and the patient. For example cameras may be placed overhead on the ceiling and on the bedside (see e.g., FIGS. 1 and 2) to capture images of the health care worker's hands, bed rails, bed table, door knobs, doors, call button, and sink area which are frequently contaminated by healthcare associated pathogens. The cameras and illumination sources of the monitor system use pulsed lighting and synchronized frame acquisition to maximize detection of fluorescent tracer particles and increase the signal to noise ratio. Pulsed lighting systems including an illuminator, a lighting controller, camera controller and a camera are described (see e.g., U.S. Patent Application No. 2012/0187838 by Hanna published on Jul. 26, 2012 and U.S. Pat. No. 7,542,628 issued to Lolacono et al. on Jun. 2, 2009 which are incorporated herein by reference). Illumination light sources (i.e., illuminators) to irradiate tracer particles in the hospital room with near infrared light may be light emitting diodes (LED) (or laser diodes) that deliver approximately 5-30 pulses of light per second. For example laser diodes that emit light at approximately 777 nm and 950 nm (the excitation maxima for the fluorescent tracer particles described above) are available from Thorlabs Imaging Systems, Sterling, Va., and a multispectral camera which detects visible and infrared light may be synchronized with the laser diodes to grab frames at the same rate, i.e. 5-30 frames per second. Multispectral cameras to detect visible and infrared wavelengths are available from FluxData Inc., Rochester, N.Y. (see e.g., Brochure: Multispectral Camera FD-1665 which is incorporated herein by reference).

The monitor system includes a computer system with image analysis software to identify fluorescent and phosphorescent emissions and to decode the identity of the tracer particles that correspond to the identity of the healthcare worker. For example, an overhead camera may detect fluorescence at 770 nm and phosphorescence at 450 nm on a bed rail in room 101 at 2 pm on Mar. 1, 2013. The optical signature, i.e., emissions at 770 nm and 450 nm, of the tracer particles on the bedrail is associated with a healthcare worker who has been assigned the corresponding tracer particles, and who has applied the tracer to his or her hands from a sanitizer container with an RFID reader that recognizes the healthcare worker's badge. In addition, the camera may record images of the healthcare worker while he or she is in the hospital room. This further detailed record may aid in identifying the healthcare worker and monitor his or her use of hand hygiene protocols. Cameras placed in the hospital room may also monitor cleaning of the hospital room as indicated by removal of any tracer particles deposited on surfaces in the hospital room. Moreover, camera images may capture images of healthcare workers cleaning the hospital room in order to monitor the cleaning procedures.

### Example 2

### Method to Monitor a Potential Spread of MRSA in a Hospital Using a Tracer System

A patient infected with methicillin resistant Staphylococcus aureus (MRSA) is placed in a private room in a hospital and “contact precautions” are observed (see e.g., “Precautions to Prevent the Spread of MRSA in Healthcare Settings” August 2010 available from Centers for Disease Control and Prevention, Atlanta, Ga. or online at: http://www.cdc.gov/mrsa/prevent/healthcare/precautions.html which is incorporated herein by reference. Healthcare workers don gloves and gown upon entry into the patient's room and remove the gown and gloves before leaving the room. Hand hygiene is performed after removing the gloves but prior to leaving the room. A monitoring system with fluorescent tracer particles and cameras is employed to monitor the healthcare workers and the hospital room surfaces they contact including the patient in the room.

A healthcare worker who attends to the patient dons gloves and a gown before entering the patient's room. The healthcare worker also applies a hand sanitizer containing unique tracer compounds to their hands and gloves before entering the room. A tracer application unit outside the room (see FIGS. 3A, 3B and 3C) dispenses a sanitizing gel to the worker's hands which contains unique tracer particles that identify the individual worker. The tracer application unit has a RFID reader which receives signals from the healthcare worker's RFID badge to identify and select tracer particle which are assigned to the worker. For example, the tracer application unit may have multiple reservoirs containing different tracer compounds, and one reservoir is activated based on signals from the worker's RFID badge to dispense a hand sanitizer containing the worker's assigned tracer particles which display a unique optical signature. Soap dispensers with RFID readers that respond to an individual's RFID badge have been described (see e.g., U.S. Patent Application 2009/0195385 by Huang et al., published on Aug. 6, 2009 which is incorporated herein by reference). Furthermore the RFID reader signals to the computer control system to activate the light sources and cameras which correspond to the worker's tracer particles. Following application of the tracer particles to his/her hands and gloves the healthcare worker enters the patient's room which has cameras to monitor the healthcare worker, the hospital room surfaces and the patient.

Cameras and light sources are strategically placed in the patient's room to image and record the healthcare workers hands and the surfaces contacted by the worker, including the patient, medical devices, bedside tables and the worker's gown and hair. Multispectral cameras with light sources are placed on the ceiling over the patient's bed, and over the wash basin or medical cart and entry door. Cameras and light sources may also be placed by the bedside or near the floor to image the worker's hands. The cameras image the healthcare worker when he/she comes into the room and they scan the room to detect tracer particles. For example multi-CCD cameras suitable for imaging in different light spectrums such as UV, VIS and NIR are available with software to control the cameras from JAI Inc., San Jose, Calif. A 3-CCD area scan camera with a VIS channel (400-700 nm) and a NIR channel (750-900 nm) may be used to detect tracer fluor emissions. See e.g., “Camera Selection Guide” available from JAI Inc., San Jose, Calif. which is incorporated herein by reference. Multiple light emitting diodes (LEDs) can be used as light sources to excite tracer fluors. For example LEDs that emit light at approximately 350 nm and 560 nm may be used to excite tracer fluors, DyLight 350 and DyLight550, which emit blue light (432 nm) and yellow light (576 nm) respectively. (LEDs are available from Thorlabs Imaging Systems, Sterling, Va. and fluorescent compounds (DyLight fluors) are available from Thermo Fisher Scientific Inc., Rockford, Ill.) Following excitation of the tracer fluors, 3-CCD cameras detect the optical signature (i.e., blue and yellow light emissions) of tracer particles in the patient's room and record the day, time, location and healthcare worker assigned to the tracer particles. The camera images are stored in a computer system and may be retrieved and analyzed at a later date or deleted after sufficient time has elapsed.

A surveillance system may observe and record activities of the healthcare worker and the presence of potential infectious agents on the healthcare worker when the healthcare worker prepares to leave the patient's room. Before leaving the patient's room the healthcare worker removes his/her gloves and gown and washes their hands as recommended for “Contact Precautions” by the Centers for Disease Control and Prevention, Atlanta, Ga. Also the healthcare worker may apply a hand sanitizer before leaving the patient's room. A CCD camera over the wash basin will image the healthcare workers gloves and hands before and after washing, and also record images of the worker's hair, the doorknob, the door and his/her exit from the room. Similar CCD cameras in hallways or other rooms can detect the presence of tracer particles applied to a healthcare worker in a first room and not removed by washing upon exiting the room. The images recorded by the monitoring system will include the date, time, location and identity of the healthcare worker and his/her associated tracer particles. The images are sent to a computer system for storage of the data. The images may be retrieved and analyzed at a later time in the event MRSA infections spread in the hospital. The potential transfer of MRSA by healthcare workers may be indicated by images of fluorescent tracer particles on the healthcare workers or hospital room surfaces prior to or concurrent with the spread of MRSA.

### Example 3

### A Method to Monitor the Tactile Contacts and the Potential Spread of Infectious Disease by Healthcare Workers in a Hospital

A monitoring system is used at a hospital to image and record the contacts made by each healthcare worker during the workday. The system includes: personalized tracer particles, a tracer application unit to identify healthcare workers and dispense tracer particles, cameras to image and record the tracer particles and a computer system to store and analyze the images. Healthcare workers apply tracer particles to their hands at the start of their workday when they arrive at the hospital.

A tracer application unit is installed at the healthcare worker's entrance to the hospital and identifies the healthcare worker by reading the worker's RFID badge. A tracer application unit (see FIGS. 3A, 3B and 3C) dispenses a sanitizing gel to the worker's hands which contains unique tracer particles that identify the individual worker. The tracer application unit has a RFID reader which receives signals from the healthcare worker's RFID badge to identify the worker and select tracer particles which are assigned to the worker. For example, the tracer application unit may have multiple reservoirs containing different tracer compounds, and one reservoir is activated based on signals from the worker's RFID badge to dispense a hand sanitizer containing the worker's assigned tracer particles which display a unique optical signature. Soap dispensers with RFID readers that respond to an individual's RFID badge have been described (see e.g., U.S. Patent Application 2009/0195385 by Huang et al., published on Aug. 6, 2009 which is incorporated herein by reference).

Tracer particles may be formulated in a hand sanitizer (e.g., Purell® hand sanitizer available from GoJo Industries, Inc., Akron, Ohio) and applied to the healthcare worker's hands, or to their gloved hands upon entering the hospital. Tracer particles formulated as liquids, gels and powders which transfer from surfaces, and objects to the hands are available from Glo Germ Company, Moab, Utah, and camera systems to quantitate transfer of fluorescent compounds to and from the hands are described (see e.g., Hubal et al., J. Expo. Anal. Environ. Epidemiol. 15: 261-270, 2005 which is incorporated herein by reference). Methods and materials to make unique tracer particles with combinations of fluorescent and phosphorescent compounds are described (see e.g., U.S. Patent Application No. 2011/0258924 by Van Asbrouck et al. published on Oct. 27, 2011 which is incorporated herein by reference). Combinations of different fluorescent and phosphorescent compounds with different absorption and emission spectra may be used to create personalized tracer particles with unique optical signatures which may be assigned to each healthcare worker. For example a unique fluorescent tracer particle may contain: 1) Dylight 800 NIR fluorescent dye (available from Thermo Fisher Scientific Inc., Rockford, Ill.) with excitation maximum at 777 nm and emission maximum at 794 nm, and 2) PTIR475/F phosphorescent particle (available from Phosphor Technology Ltd., Stevenage, Herts, UK) with excitation maximum at 950 nm and emission maximum at 480 nm. Excitation of the tracer particle with NIR light will result in fluorescence at 794 nm and phosphorescence at 480 nm, a unique optical signature, which may be associated with a specific healthcare worker. It is possible to create different tracer particles with unique optical signatures by combining different phosphors and fluors, e.g., 24-36 unique optical signatures may be created by combining fluors and phosphors (see e.g., U.S. Patent Application No. 2011/0258924, Ibid.). Thus distinct tracer particles assigned to each healthcare worker are applied to their hands upon entering the hospital and detected throughout the day by cameras strategically placed throughout the hospital.

Cameras and light sources are strategically placed in the hospital to image and record the healthcare worker's hands and the surfaces contacted by the worker, including patients, medical devices, bedside tables, wash basins, doors, doorknobs, entrances, exits and also the worker's clothing and hair. Multispectral cameras with light sources may be used to detect tracer particles with different fluors and phosphors. For example multi-CCD cameras suitable for imaging in different light spectrums such as UV, VIS and NIR with software to control the cameras are available from JAI Inc., San Jose, Calif. A 3-CCD area scan camera with a VIS channel (400-700 nm) and a NIR channel (750-900 nm) may be used to detect fluor and phosphor emissions. See e.g., “Camera Selection Guide” available from JAI Inc., San Jose, Calif. which is incorporated herein by reference. Multiple light emitting diodes (LEDs) can be used as light sources to excite different tracer fluors and phosphors. For example UV, VIS and IR LEDs are available. See e.g., the Overview Page: Unmounted LEDs from Thorlabs Imaging Systems, Sterling, Va. which is incorporated herein by reference. Images recorded throughout the hospital are marked with the date, time and location, e.g., room number, floor, hospital wing, of the recording. Also the images are stored on a computer system for analysis at a later time if necessary. Image analysis software may be used to detect and identify tracer particles based on their optical signatures which are deposited on hospital surfaces. Moreover the healthcare workers assigned to the tracer particles are identified. The monitoring system may also be used to monitor cleaning of hospital surfaces. The removal of any tracer particles deposited on hospital surfaces may be documented by the time- and date-stamped images stored in the computer system. Daily cleaning of hospital surfaces also establishes a tracer-free baseline from which to detect tracer particle deposition. Data from the monitoring system may be searched for specific days, specific locations, e.g., room numbers, and specific tracer particles, e.g., tracer particles assigned to an individual healthcare worker. This data can be used to assemble a digital record detailing the potential contamination status of environmental surfaces and the potential infectious status of healthcare workers or patients. A healthcare worker who has been identified by cameras to have contacted a potentially infectious patient or a contaminated surface can be assigned a infective score denoting him or her as potentially infected. Thereafter, other surfaces or personnel contacted by the healthcare worker can likewise be assigned scores indicating potential contamination or infection.

Each recited range includes all combinations and sub-combinations of ranges, as well as specific numerals contained therein.

All publications and patent applications cited in this specification are herein incorporated by reference to the extent not inconsistent with the description herein and for all purposes as if each individual publication or patent application were specifically and individually indicated to be incorporated by reference for all purposes.

Those having ordinary skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having ordinary skill in the art will recognize that there are various vehicles by which processes and/or systems and/or other technologies disclosed herein can be effected (e.g., hardware, software, and/or firmware), and that the preferred vehicle will vary with the context in which the processes and/or systems and/or other technologies are deployed. For example, if a surgeon determines that speed and accuracy are paramount, the surgeon may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies disclosed herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those having ordinary skill in the art will recognize that optical aspects of implementations will typically employ optically-oriented hardware, software, and or firmware.

In a general sense the various aspects disclosed herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices disclosed herein, or a microdigital processing unit configured by a computer program which at least partially carries out processes and/or devices disclosed herein), electrical circuitry forming a memory device (e.g., forms of random access memory), and/or electrical circuitry forming a communications device (e.g., a modem, communications switch, or optical-electrical equipment). The subject matter disclosed herein may be implemented in an analog or digital fashion or some combination thereof.

At least a portion of the devices and/or processes described herein can be integrated into a data processing system. A data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

The herein described components (e.g., steps), devices, and objects and the description accompanying them are used as examples for the sake of conceptual clarity and that various configuration modifications using the disclosure provided herein are within the skill of those in the art. Consequently, as used herein, the specific examples set forth and the accompanying description are intended to be representative of their more general classes. In general, use of any specific example herein is also intended to be representative of its class, and the non-inclusion of such specific components (e.g., steps), devices, and objects herein should not be taken as indicating that limitation is desired.

With respect to the use of substantially any plural or singular terms herein, the reader can translate from the plural to the singular or from the singular to the plural as is appropriate to the context or application. The various singular/plural permutations are not expressly set forth herein for sake of clarity.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable or physically interacting components or wirelessly interactable or wirelessly interacting components or logically interacting or logically interactable components.

While particular aspects of the present subject matter described herein have been shown and described, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an”; the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, or A, B, and C together, etc.). Virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for monitoring potential spread of an infectious agent in an environment comprising:
providing a detectable marker/tracer for emplacement on one or more body regions of a subject at a time when the subject is entering the environment;
identifying a unique tag/identifier associating the detectable marker/tracer with the subject;
observing with a camera the marker/tracer in the environment; and
detecting a transfer of the marker/tracer from the one or more body regions of the subject to one or more surfaces of the environment.

2.-8. (canceled)

9. The method of claim 1, comprising detecting a tune of a change in distribution of the marker/tracer on the one or more body regions of the subject.

10.-11. (canceled)

12. The method of claim 1, comprising detecting a time of a change in distribution of the marker/tracer on the one or more surfaces of the environment, and associating the change with an interaction event by the subject.

13. The method of claim 1, comprising detecting a change in distribution of the unique tag/identifier on the one or more surfaces of the environment.

14. (canceled)

15. The method of claim 1, comprising:
tracking a position of the one or more body regions of the subject in the environment.

16.-19. (canceled)

20. The method of claim 1, comprising:
alerting a third party of the detected transfer of the marker/tracer to the one or more surfaces of the environment.

21. (canceled)

22. The method of claim 1, comprising:
coordinating a history of the detected transfer of the marker/tracer with a contamination status of the surface of the environment or with an infective status of the subject.

23. (canceled)

24. The method of claim 1, comprising:
observing with the camera the marker/tracer on the one or more body regions of the subject;
alerting the subject to a status of the marker/tracer on the one or more body regions.

25. (canceled)

26. The method of claim 1, wherein detecting the transfer of the marker/tracer from the one or more body regions of the subject to one or more surfaces of the hospital environment comprises, detecting a transfer of the marker/tracer from the one or more body regions of the subject to one or more second subjects in the hospital environment.

27.-31. (canceled)

32. A method for monitoring potential spread of an infectious agent in a hospital environment comprising:
providing a detectable marker/tracer for emplacement on one or more body regions of a subject at a time when the subject is in the hospital environment;
identifying a unique tag/identifier associating the detectable marker/tracer with the subject;
observing with a camera the marker/tracer in the hospital environment; and
detecting a transfer of the marker/tracer from the one or more body regions of the subject to one or more surfaces of the hospital environment.

33. The method of claim 32, comprising observing the unique tag/identifier with the camera.

34. The method of claim 32, wherein the unique tag/identifier is identified by a spectral signature.

35. The method of claim 32, wherein the unique tag/identifier is identified by a fluorescence signature.

36. The method of claim 32, wherein the unique tag/identifier is identified by a fluorescence time signature.

37. The method of claim 32, comprising providing the subject with a different unique tag/identifier than one currently detected in the environment by the camera.

38. The method of claim 32, wherein the one or more body regions include one or more of hands, arms, legs, feet, head, or torso of the subject.

39. The method of claim 32, comprising:
detecting a change in distribution of the marker/tracer on the one or more body regions of the subject.

40. The method of claim 39, comprising detecting a time of the change in the distribution of the marker/tracer.

41. The method of claim 32, comprising:
detecting a change in distribution of the marker/tracer on the one or more surfaces of the environment.

42. The method of claim 41, comprising detecting a time of the change in the distribution of the marker/tracer.

43. The method of claim 42, comprising associating the change with an interaction event by the subject.

44. The method of claim 32, comprising detecting a change in distribution of the unique tag/identifier on the one or more surfaces of the environment.

45. The method of claim 44, comprising detecting the time of the change.

46. The method of claim 32, comprising:
tracking a position of the one or more body regions of the subject in the environment.

47. The method of claim 32, comprising:
identifying a unique tag/identifier with a location in the environment.

48. The method of claim 32, comprising:
alerting a third party of the detected transfer of the marker/tracer to the one or more surfaces of the environment.

49. The method of claim 32, comprising:
coordinating a history of the detected transfer of the marker/tracer with a contamination status of the surface of the environment or with an infective status of the subject.

50. The method of claim 32, comprising:
observing with the camera the marker/tracer on the one or more body regions of the subject;
alerting the subject to a status of the marker/tracer on the one or more body regions.

51. The method of claim 32, comprising:
detecting a degree of removal of the marker/tracer from the one or more body regions of the subject.

52. The method of claim 32, wherein detecting the transfer of the marker/tracer from the one or more body regions of the subject to one or more surfaces of the hospital environment comprises: detecting a transfer of the marker/tracer from the one or more body regions of the subject to one or more subjects in the hospital environment.

53. The method of claim 52, comprising changing an infection status of the second subject.

54. The method of claim 32, comprising detecting a transfer of the marker/tracer from a surface of the environment to the second subject.

55. The method of claim 54, comprising changing an infection status of the second subject.

56. The method of claim 32, comprising detecting removal of the marker/tracer from the hands or arms of the subject via a washing activity.

57. The method of claim 56, comprising changing an infection status of the subject.

58. A system comprising:
one or more recognition devices configured to identify a subject in an environment;
one or more dispensers configured to dispense a detectable marker/tracer compound to one or more body regions of the subject, wherein the detectable marker/tracer compound is unique to the subject;
one or more cameras configured to detect the marker/tracer in the environment; and
a computing system configured to record and to correlate the location of the marker/tracer in the environment and the unique tag/identifier associated with the subject.

59. The system of claim 58, wherein the computing system is configured to identify a change in distribution of the marker/tracer on a surface of the environment with an emplacement event of the detectable marker/tracer on the subject.

60. The system of claim 58, wherein the computing system utilizing data from the one or more cameras is configured to detect a change in distribution of the marker/tracer on one or more body regions of the subject.

61. The system of claim 58, wherein the computing system utilizing data from the one or more cameras is configured to detect a change in distribution of the marker/tracer on the one or more surfaces of the environment.

62. The system of claim 61, wherein the data from the one or more cameras are configured to identify a change in distribution of the marker/tracer on a surface of the environment with an emplacement event of the detectable marker/tracer on the subject.

63. The system of claim 58, wherein the marker/tracer is detectable in infrared light, visible light, or ultraviolet light.

64. The system of claim 58, wherein the computing system utilizing data from the one or more cameras is configured to detect the marker/tracer on the one or more hands of the subject, and configured to alert the subject to a status of the marker/tracer on the one or more hands.

65. The system of claim 58, wherein the computing system utilizing data from the one or more cameras is configured to alert a third party of a detected transfer of the marker/tracer to the one or more surfaces of the environment.

66. The system of claim 58, wherein the one or more recognition devices include one or more RFID readers.

67. The system of claim 58, wherein the one or more recognition devices comprises a facial recognition system.

68. The system of claim 58, wherein the environment includes a hospital environment.

69. The system of claim 58, wherein the computing system is configured to coordinate a history of a detected transfer of the marker/tracer to the one or more surfaces of the environment or to the subject with a contamination status of the surface of the environment or with an infective status of the subject.

70. The system of claim 58, wherein the one or more cameras is configured to detect a transfer of the marker/tracer from the one or more body regions of the subject to one or more second subjects in the hospital environment.

71. The system of claim 70, wherein the computing system is configured to record a change in an infection status of the second subject.

72. (canceled)

73. A system comprising:
at least one computer program included on a computer-readable medium for use with at least one computer system wherein the computer program includes a plurality of instructions including,
one or more instructions for monitoring potential spread of an infectious agent in an environment including receiving data from one or more recognition devices configured to identify a subject in an environment;
one or more instructions for receiving data from one or more dispensers configured to dispense a marker/tracer compound to one or more body regions of the subject, wherein the detectable marker/tracer compound is unique to the subject;
one or more instructions for receiving data from one or more cameras configured to detect the marker/tracer in the environment; and
one or more instructions for receiving data from and sending data to a computing system configured to record and to correlate the location of the marker/tracer in the environment and the unique tag/identifier associated with the subject.

74. (canceled)
